(19) United States
(12) Patent Application Publication
(10) Pub. No.: US 2007/0030894 A1
(43) Pub. Date: Feb. 8, 2007

(54) Method, device, and module for improved encoding mode control in video encoding

(75) Inventors: Dong Tian, Tampere (FI); Kemal Ugur, Tampere (FI); Stephan Wenger, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/197,763

(22) Filed: Aug. 3, 2005

(51) Int. Cl. H04N 7/12; H04B 1/66

(52) U.S. Cl. 375/240.02; 375/240.27

(57) ABSTRACT

In general the present invention provides a video encoder, which is arranged for adaptive encoding mode selection. The video encoder is operable with a plurality of encoding modes for encoding a current macroblock of a video sequence. The video sequence is preferably intended for being transmitted by a communication network, e.g. any circuit-switched or packet-switched communication network. A distortion estimator is arranged for estimating expected distortion values due to potential erroneous transmission of the current macroblock in dependence of the encoding modes. A decision module is arranged for selecting a final encoding mode from the plurality of encoding modes on the basis of the distortion values and encoding parameters. Further, a table is provided, which is referenced by the spatial position of the macroblock and which is updated with an accumulated distortion value. The video encoder is arranged for applying the final encoding mode for encoding the current macroblock.

### TECHNICAL FIELD

The present invention relates to the field of digital video processing. In particular, the present invention relates to the video encoding.

### BACKGROUND OF THE INVENTION

Video compression standards have been developed over the last decades and form the enabling technology for today's digital television broadcasting systems. The focus of all current video compression standards lies on the bit stream syntax and semantics, and the decoding process. Also existing are non-normative guideline documents, commonly known as test models that describe encoder mechanisms. They consider specifically bandwidth requirements and data transmission rate requirements. Storage and broadcast media targeted by the former development include digital storage media such as DVD (digital versatile disc) and television broadcasting systems such as digital satellite (e.g. DVB-S: digital video broadcast-satellite), cable (e.g. DVB-C: digital video broadcast-cable), and terrestrial (e.g. DVB-T: digital video broadcast-terrestrial) platforms. Efforts have been concentrated on an optimal bandwidth usage, in particular to DVB-T standard, where there is insufficient radio frequency spectrum available. However, these storage and broadcast media essentially guarantee a sufficient end-to-end quality of service. Consequently, quality of service aspects have only been considered with minor importance.

In recent years, however, packet-switched data communication networks such as the Internet have increasingly gained importance for transfer/broadcast of multimedia contents including of course digital video sequences. In principle, packet-switched data communication networks are subjected to limited end-to-end quality of service in data communications comprising essentially packet erasures, packet losses, and/or bit failures, which have to be dealt with to ensure failure free data communications. In packet-switched networks, data packets may be discarded due to buffer overflow at intermediate nodes of the network, may be lost due to transmission delays, or may be rejected due to queuing misalignment on receiver side.

Moreover, wireless packet-switched data communication networks with considerable data transmission rates enabling transmission of digital video sequences are available and the market of end users having access thereto is developing. It is anticipated that such wireless networks form additional bottlenecks in end-to-end quality of service. Especially, 3^{rd} generation public land mobile networks such as UMTS (Universal Mobile Telecommunications System) and improved 2^{nd} generation public land mobile networks such as GSM (Global System for Mobile Communications) with GPRS (General Packet Radio Service) and/or EDGE (Enhanced Data for GSM Evolution) capability are supposed for digital video broadcasting. Nevertheless, limited end-to-end quality of service can be also experienced in wireless data communications networks for instance in accordance with any IEEE (Institute of Electrical & Electronics Engineers) 802.xx standard.

In addition, video communication services now become available over wireless circuit switched services, e.g. in the form of 3G.324M video conferencing in UMTS networks. In this environment, the video bit stream may be exposed to bit errors and to erasures.

The invention presented is suitable for video encoders generating video bit streams to be conveyed over all mentioned types of networks. For the sake of simplification, but not limited thereto, following embodiments are focused henceforth on the application of error resilient video coding for the case of packet-switched erasure prone communication.

With reference to present video encoding standards employing predictive video encoding, errors in a compressed video (bit-) stream, for example in the form of erasures (through packet loss or packet discard) or bit errors in coded video segments, significantly reduce the reproduced video quality. Due to the predictive nature of video, where the decoding of frames depends on frames previously decoded, errors may propagate and amplify over time and cause seriously annoying artifacts. This means that such errors cause substantial deterioration in the reproduced video sequence. Sometimes, the deterioration is so catastrophic that the observer does not recognize any structures in a reproduced video sequence.

Decoder-only techniques that combat such error propagation and are known as error concealment help to mitigate the problem somewhat, but those skilled in the art will appreciate that encoder-implemented tools are required as well. Since the sending of complete intra frames leads to large picture sizes, this well-known error resilience technique is not appropriate for low delay environments such as conversational video transmission.

Ideally, a decoder would communicate to the encoder areas in the reproduced picture that are damaged, so to allow the encoder to repair only the affected area. This, however, requires a feedback channel, which in many applications is not available. In other applications, the round-trip delay is too long to allow for a good video experience. Since the affected area (where the loss related artifacts are visible) normally grows spatially over time due to motion compensation, a long round trip delay leads to the need of more repair data which, in turn, leads to higher (average and peak) bandwidth demands. Hence, when round trip delays become large, feedback-based mechanisms become much less attractive.

Forward-only repair algorithms do not rely on feedback messages, but instead select the area to be repaired during the mode decision process, based only on knowledge available locally at the encoder. Of these algorithms, some modify the mode decision process such to make the bit stream more robust, by placing non-predictively (intra) coded regions in the bit stream even if they are not optimal from the rate-distortion model point of view. This class of mode decision algorithms is commonly referred to as intra refresh. In most video codecs, the smallest unit which allows an independent mode decision is known as a macroblock. Algorithms that select individual macroblocks for intra coding so to preemptively combat possible transmission errors are known as intra refresh algorithms.

Random Intra refresh (RIR) and cyclic Intra refresh (CIR) are well known methods and used extensively. In Random Intra refresh (RIR), the Intra coded macroblocks are selected randomly from all the macroblocks of the picture to be coded, or from a finite sequence of pictures. In accordance with cyclic Intra refresh (CIR), each macroblock is Intra updated at a fixed period, according to a fixed “update pattern”. Neither algorithm takes the picture content or the bit stream properties into account.

The test model developed by ISO/IEC JTC1/SG29 to show the performance of the MPEG-4 Part 2 standard contains an algorithm known as Adaptive Intra refresh (AIR). Adaptive Intra refresh (AIR) selects those macroblocks, which have a largest sum of absolute difference (SAD), calculated between the spatially corresponding, motion compensated macroblock in the reference picture buffer.

The test model developed by the Joint Video Team (JVT) to show the performance of the ITU-T Recommendation H.264 contains a high complexity macroblock selection method that places intra macroblocks according to the rate-distortion characteristics of each macroblock, and it is called Loss Aware Rate Distortion Optimization (LA-RDO). Loss Aware Rate Distortion Optimization (LA-RDO) algorithm simulates a number of decoders at the encoder and each simulated decoder independently decodes the macroblock at the given packet loss rate. For more accurate results, simulated decoders also apply error-concealment if the macroblock is found to be lost. The expected distortion of a macroblock is averaged over all the simulated decoders and this average distortion is used for mode selection. Loss Aware Rate Distortion Optimization (LA-RDO) generally gives good performance, but it is not feasible for many implementations as the complexity of the encoder increases significantly due to simulating a potentially large number of decoders.

Another method with high complexity is known as Recursive Optimal per-pixel Estimate ROPE. ROPE is believed to quite accurately predict the distortion if the macroblock is lost. However, similar to Loss Aware Rate Distortion Optimization (LA-RDO), ROPE has high complexity, because it needs to make computations on pixel level.

### SUMMARY OF THE INVENTION

An object of the present invention is to provide a concept, which overcomes the aforementioned drawbacks. In particular, the object of the present invention is to provide a concept for improving the robustness of a digitally compressed video sequence by the means of an advantageous coding of the video sequence. Moreover, video encoders in battery powered devices, such as mobile phones preferably with image/video capturing capability, have very strict constraints in computational complexity. In order to enhance the end user experience for these types of devices, lightweight (in terms of computing cycles and memory demand), yet efficient mechanisms in video encoders are required.

The object is solved by a method, a computer program product, a device, and a system as defined in the accompanying claims.

According to an aspect of the present invention, a method for adaptive encoding mode selection applicable with a video encoder is provided. The video encoder is operable with a plurality of encoding modes for macroblock encoding of a video sequence. The adaptive encoding mode selection is applicable on the macroblock level. The video sequence is preferably intended, but not limited thereto, for being transmitted over an error prone communication network, preferably any packet-switched and/or circuit-switched network. First, expected distortion values due to potential erroneous transmission of a current macroblock are estimated in dependence of the available encoding modes. The estimations are preferably performed on the basis of calculations enabling determination of the expected distortion values. A final encoding mode is selected from the plurality of encoding modes on the basis of the distortion values and encoding parameters. A distortion value is estimated for each encoding mode and a set of encoding parameters is associated with each encoding mode. A table, referenced by the spatial position of the macroblock in the video sequence, is updated with an accumulated distortion value. The final encoding mode is applicable for macroblock encoding.

According to an embodiment of the present invention, the accumulated distortion value, which is maintained in the table, is updated by that expected distortion value, which is associated with the selected final encoding mode. This means that the accumulated distortion value representing an abstract number indicating expected distortion due to transmission errors is updated each time a macroblock is encoded. The accumulated distortion value is maintained on the basis of the table. Preferably, the accumulated distortion value is initially zero. Due to its functionality, the table may be designated channel distortion table indicating that the table is provided for maintaining channel distortion values defined above.

According to an embodiment of the present invention, cost values are determined for each encoding mode. Each cost value of a specific encoding mode depends on the distortion value of the specific encoding mode and encoding parameters of the specific encoding mode. The final encoding mode is selected from the plurality of encoding modes on the basis of a comparison of the cost values each being associated with one specific encoding mode of the plurality thereof. In particular, the smallest cost value is selected for the final encoding mode.

According to an embodiment of the present invention, the plurality of encoding modes comprises at least an “Intra” encoding mode. A distortion value for the “Intra” encoding mode of the macroblock is estimated from distortion terms. The distortion terms comprise, in a not limited way, a first term, which describes a distortion due to error concealment, and a second term, which describes a distortion due to a previous erroneous transmitted macroblock.

According to an embodiment of the present invention, the plurality of encoding modes comprises at least an “Inter” encoding mode. A distortion value for “Inter” encoding mode encoding of the macroblock is estimated from distortion terms. The distortion terms comprise, in a not limiting way, the first term, which describes a distortion due to error concealment, and the second term, which describes a distortion due to a previous erroneous transmitted macroblock, and a third distortion term, which describes a distortion due to error propagation.

According to an embodiment of the present invention, the distortion term describing the distortion due to error concealment comprises a deviation value. The deviation value is obtained from a macroblock, which is assumed to be transmitted erroneously, and a co-located macroblock at a previous frame, which co-located macroblock is applicable for error concealment intended for application due to the assumption of the erroneous transmission of the macroblock. The distortion term describing the distortion due to error concealment comprises additionally a probability value relating to potentially erroneous transmission of the current macroblock. In particular, the deviation value is rated by the probability value relating to erroneous transmission.

According to an embodiment of the present invention, the distortion term describing the distortion due to a previous erroneous transmitted macroblock comprises a distortion value, which has been estimated for the previous macroblock. The estimation of the distortion value of the previous macroblock is performed in accordance with any embodiment of the present invention and especially on the basis of an embodiment of the method described here. The distortion value of the previous macroblock describes a distortion resulting from a potential erroneous macroblock transmitted previously. The distortion term describing the distortion due to previous erroneous transmitted macroblock comprises additionally a probability value relating to potentially erroneous transmission of the current macroblock. In particular, the distortion value of the previous macroblock is rated by the probability value relating to erroneous transmission.

According to an embodiment of the present invention, the distortion term describing the distortion due to error propagation comprises a weighted average distortion value. The weighted average distortion value is determinable from distortion values of reference macroblocks at a previous frame. The reference macroblocks are determinable from a motion vector and are used as references for predicting the macroblock. The distortion term describing the distortion due to error propagation comprises additionally a probability value relating to a non-occurrence of potentially erroneous transmission of the current macroblock. In particular, the distortion term describing the distortion due to error propagation is rated by the probability value relating to the non-occurrence of potentially erroneous transmission. It should be noted that the sum of the probability value relating to potentially erroneous transmission of the current macroblock and the probability value relating to the non-occurrence of potentially erroneous transmission is equal to one.

According to an embodiment of the present invention, the weighted average distortion value is obtained from distortion values of the macroblocks used as references, which distortion values are weighted by weight values to allow for obtaining the average distortion value thereof. The weight values are proportional to areas of the reference macroblocks, which areas are used as references for the current macroblock.

In brief summary, for each macroblock position, the accumulated distortion value, which represents an abstract representation, is maintained. The accumulated distortion value indicates the “distortion” and is updated each time a macroblock is encoded. Initially, the accumulated distortion value is preferably zero. When the macroblock is coded in “Inter” encoding mode, the accumulated distortion value is increased in accordance with the above described distortion value for “Inter” encoding mode. This distortion value reflects the added distortion (worse quality) of the macroblock in question under error prone conditions. When the macroblock is coded in “Intra” encoding mode, the distortion is obtained in accordance with the distortion value for “Intra” encoding mode described above. This distortion value does not include a distortion term resulting from error propagation. In other words, for “Inter” encoding, the quality degradation resulting from previous (perhaps lost) transmissions is accumulated.

According to an embodiment of the present invention, the distortion value for “Intra encoding” mode is estimated in accordance with following equation:
D_{c}^{I}(n,i)=p·Σ(\hat{F}(n,i)−\hat{F}(n−1,i))²+p·D_{c}(n−1,i);
where p is the packet loss probability, n is the frame number, i is the macroblock number, and \hat{F}(n,i) is the reconstructed macroblock in the case of error free transmission.

According to an embodiment of the present invention, the distortion value for “Inter” encoding mode is estimated in accordance with following equation:
D_{c}^{P}(n,i)=(1−p)· D̅_{c}(n_{ref},i)+p·Σ(\hat{F}(n,i)−\hat{F}(n−1,i))²+p·D_{c}(n−1,i);
where (1−p)· D̅_{c}(n_{ref},i) is the additional term resulting from error propagation, and D̅_{c}(n_{ref},i) is the weighted average channel distortion of all the macroblocks that current macroblock uses as reference.

According to an embodiment of the present invention, the cost values for each encoding mode is determined in that, for each encoding mode, a quantization distortion value is determined, which results from a quantization operation applicable on the macroblock, a Lagrangian parameter associated with the encoding mode and number of bits required for encoding the macroblock in accordance with the encoding mode is provided, and the cost value is determined in dependence from the quantization distortion value, the Lagrangian parameter, the number of bits, and the distortion value associated with the encoding mode.

According to an embodiment of the present invention, the cost value for one encoding mode out of the plurality of encoding modes is determined in accordance with following equation:
J=D_{S}(n,i)+D_{C}(n,i)+λ_{mode}·R(·);
where Dₛ(n,i) is a distortion value caused by quantization, D_{C}(n,i) is the expected distortion value determined in accordance with the one encoding mode, R is the number of bits that would be used for encoding the current macroblock, and λ_{mode} is the Lagrangian parameter preferably depending on the one encoding mode.

According to another aspect of the present invention, a computer program product comprising a computer readable medium having a program code recorded thereon is provided. The program code is adapted for adaptive encoding mode selection applicable with a video encoder operable with a plurality of encoding modes for encoding a current macroblock of a video sequence. The video sequence is preferably intended for being transmitted over an error prone communication network, preferably any packet-switched and/or circuit-switched network. The program code comprising the video encoder, a code section for estimating expected distortion values due to potential erroneous transmission of the current macroblock in dependence of the encoding modes, a code section for selecting a final encoding mode from the plurality of encoding modes on the basis of the distortion values and encoding parameters, a table, which is referenced by the spatial position of the video sequence at which the current macroblock is arranged, is updated with an accumulated distortion value, and a code section for applying the final encoding mode for encoding the current macroblock.

According to an embodiment of the present invention, the accumulated distortion value is updated by that expected distortion value, which is associated with the selected final encoding mode. This means that the accumulated distortion value representing an abstract number indicating expected distortion due to transmission errors is updated each time a macroblock is encoded. The accumulated distortion value is maintained on the basis of the table. Preferably, the accumulated distortion value is initially zero.

According to an embodiment of the present invention, a code section for determining a cost value for each encoding mode on the basis of the distortion values and encoding parameters is additionally provided. The code section for selecting is arranged to select a final encoding mode from the plurality of encoding modes on the basis of a comparison of the cost values.

According to an embodiment of the present invention, the plurality of encoding modes comprises at least Intra encoding mode. A code section for estimating a distortion value for Intra mode encoding of the current macroblock from distortion terms is provided. The distortion terms comprise a term describing distortion due to error concealment and a term describing distortion due to a previous erroneous transmitted macroblock.

According to an embodiment of the present invention, the plurality of encoding modes comprises at least Inter encoding mode. A code section for estimating a distortion value for Intra mode encoding of the current macroblock from distortion terms is provided. The distortion terms comprises the term describing distortion due to error concealment, the term describing distortion due to a previous erroneous transmitted macroblock, and a term describing distortion due to error propagation.

According to an embodiment of the present invention, the distortion term, which describes the distortion due to error concealment, comprises a deviation value, which is obtained from the current macroblock and a co-located macroblock at a previous frame. The co-located macroblock at a previous frame is intended for application in case of required error concealment due to erroneous transmission of the current macroblock. The distortion term comprises additionally a probability value relating to erroneous transmission of the current macroblock.

According to an embodiment of the present invention, the distortion term, which describes the distortion due to previous erroneous transmitted macroblock, comprises a distortion value, which is estimated for a macroblock at a previous frame, which has been potentially transmitted erroneously, and a probability value relating to erroneous transmission of the current macroblock.

According to an embodiment of the present invention, the distortion term, which describes the distortion due to error propagation, comprises a weighted average distortion value. The weighted average distortion value is determinable from distortion values of reference macroblocks at a previous frame. The reference macroblocks are used as references and determinable from a motion vector obtained from motion estimation. The distortion term describing the distortion due to error propagation comprises additionally a probability value relating to a non-occurrence of erroneous transmission of the current macroblock.

According to an embodiment of the present invention, the weighted average distortion value is obtained from distortion values of the reference macroblocks, which distortion values are weighted by weight values for averaging, which weight values are proportional to areas of the reference macroblocks, which areas are used as references for predicting the current macroblock.

According to an embodiment of the present invention, the distortion value for “Intra encoding” mode is estimated in accordance with following equation:
D_{c}^{I}(n,i)=p·Σ(\hat{F}(n,i)−\hat{F}(n−1,i))²+p·D_{c}(n−1,i);
where p is the packet loss probability, n is the frame number, i is the macroblock number, and \hat{F}(n,i) is the reconstructed macroblock in the case of error free transmission.
According to an embodiment of the present invention, the distortion value for “Inter” encoding mode is estimated in accordance with following equation:
D_{c}^{P}(n,i)=(1−p)· D̅_{c}(n_{ref},i)+p·Σ(\hat{F}(n,i)−\hat{F}(n−1,i))²+p·D_{c}(n−1,i);
where (1−p)· D̅_{c}(n_{ref},i) is the additional term resulting from error propagation, and D̅_{c}(n_{ref},i) is the weighted average channel distortion of all the macroblocks that current macroblock uses as reference.

According to an embodiment of the present invention, the code section for determining the cost values for each encoding mode comprises, for each encoding mode, a code section for determining a quantization distortion value resulting from a quantization operation applicable on the current macroblock, a code section for providing a Lagrangian parameter associated with the encoding mode and number of bits required for encoding the current macroblock in accordance with the encoding mode, and a code section for determining the cost value in dependence from the quantization distortion value, the Lagrangian parameter, the number of bits, and the distortion value associated with the encoding mode.

According to an embodiment of the present invention, the cost value for one encoding mode out of the plurality of encoding modes is determined in accordance with following equation:
J=D_{S}(n,i)+D_{C}(n,i)+λ_{mode}·R(·);
where Dₛ(n,i) is a distortion value caused by quantization, D_{C}(n,i) is the expected distortion value determined in accordance with the one encoding mode, R is the number of bits that would be used for encoding the current macroblock, and λ_{mode} is the Lagrangian parameter preferably depending on the one encoding mode.

According to another aspect of the present invention, video encoder arranged for adaptive encoding mode selection is provided. The video encoder is operable with a plurality of encoding modes for encoding a current macroblock of a video sequence. The video sequence is preferably intended for being transmitted over an error prone communication network, preferably any packet-switched and/or circuit-switched network. A distortion estimator is arranged for estimating expected distortion values due to potential erroneous transmission of the current macroblock in dependence of the encoding modes. A decision module is arranged for selecting a final encoding mode from the plurality of encoding modes on the basis of the distortion values and encoding parameters. Further, a table is comprised, which is referenced by the spatial position of the currently encoded macroblock in the video sequence and which is updated with an accumulated distortion value. The video encoder is arranged for applying the final encoding mode for encoding the current macroblock.

According to an embodiment of the present invention, the accumulated distortion value is updated by that expected distortion value, which is associated with the selected final encoding mode. This means that the accumulated distortion value representing an abstract number indicating expected distortion due to transmission errors is updated each time a macroblock is encoded. The accumulated distortion value is maintained on the basis of the table. Preferably, the accumulated distortion value is initially zero.

According to an embodiment of the present invention, a cost calculator is arranged for determining a cost value for each encoding mode on the basis of the distortion values and encoding parameters. The decision module is arranged for selecting a final encoding mode from the plurality of encoding modes on the basis of a comparison of the cost values.

According to an embodiment of the present invention, the plurality of encoding modes comprises at least Intra encoding mode. The distortion estimator is arranged for estimating a distortion value for Intra mode encoding of the current macroblock from distortion terms describing distortion due to error concealment and distortion due to a previous erroneous transmitted macroblock.

According to an embodiment of the present invention, the plurality of encoding modes comprises at least Inter encoding mode. The distortion estimator arranged for estimating a distortion value for Intra mode encoding of the current macroblock from distortion terms describing distortion due to error concealment, distortion due to a previous erroneous transmitted macroblock and distortion due to error propagation.

According to an embodiment of the present invention, the distortion term describing the distortion due to error concealment comprises a deviation value obtained from the current macroblock and a co-located macroblock at a previous frame applicable for error concealment and a probability value relating to erroneous transmission of the macroblock.

According to an embodiment of the present invention, the distortion term describing the distortion due to previous erroneous transmitted macroblock comprises a distortion value estimated for a macroblock at a previous frame, which is potentially transmitted erroneously, and a probability value relating to erroneous transmission of the macroblock.

According to an embodiment of the present invention, the distortion term describing the distortion due to error propagation comprises a weighted average distortion value determinable from distortion values of reference macroblocks at a previous frame, which are used as references and determinable from a motion vector. The distortion term describing the distortion due to error propagation comprises additionally a probability value relating to a non-occurrence of erroneous transmission of the macroblock.

According to an embodiment of the present invention, the weighted average distortion value is obtained from distortion values of the reference macroblocks. The distortion values are weighted by weight values for averaging, which weight values are proportional to areas of the reference macroblocks, which areas are used as references for predicting the current macroblock.

According to an embodiment of the present invention, the distortion estimator is arranged for estimating the distortion value for Intra encoding modes in accordance with following equation:
D_{c}^{I}(n,i)=p·Σ(\hat{F}(n,i)−\hat{F}(n−1,i))²+p·D_{c}(n−1,i);
where p is the packet loss probability, n is the frame number, i is the macroblock number, and \hat{F}(n,i) is the reconstructed macroblock in the case of error free transmission.

According to an embodiment of the present invention, the distortion estimator is arranged for estimating the distortion value for Inter encoding modes in accordance with following equation:
D_{c}^{P}(n,i)=(1−p)· D̅_{c}(n_{ref},i)+p·Σ(\hat{F}(n,i)−\hat{F}(n−1,i))²+p·D_{c}(n−1,i);
where (1−p)·D_{c}(n_{ref},i) is the additional term resulting from error propagation, and D̅_{c}(n_{ref},i) is the weighted average channel distortion of all the macroblocks that current macroblock uses as reference.

According to an embodiment of the present invention, the cost calculator arranged for determining the cost values for each encoding mode is also arranged for, for each encoding mode, determining a quantization distortion value resulting from a quantization operation applicable on the current macroblock, providing a Lagrangian parameter associated with the encoding mode and number of bits required for encoding the current macroblock in accordance with the encoding mode; and determining the cost value in dependence from the quantization distortion value, the Lagrangian parameter, the number of bits, and the distortion value associated with the encoding mode.

According to an embodiment of the present invention, the cost calculator is arranged for determining the cost value for one encoding mode out of the plurality of encoding modes in accordance with following equation:
J=D_{S}(n,i)+D_{C}(n,i)+λ_{mode}·R(·);
where Dₛ(n,i) is a distortion value caused by quantization, D_{C}(n,i) is the expected distortion value determined in accordance with the one encoding mode, R is the number of bits that would be used for encoding the current macroblock, and λ_{mode} is the Lagrangian parameter preferably depending on the one encoding mode.

According to another aspect of the present invention, processing device operable with a video encoder is provided. The video encoder is arranged for adaptive encoding mode selection. The video encoder is operable with a plurality of encoding modes for encoding a current macroblock of a video sequence. The video sequence is preferably intended for being transmitted over an error prone communication network, preferably any packet-switched and/or circuit-switched network. A distortion estimator is arranged for estimating expected distortion values due to potential erroneous transmission of the current macroblock in dependence of the encoding modes. A decision module is arranged for selecting a final encoding mode from the plurality of encoding modes on the basis of the distortion values and encoding parameters. Further, a table is comprised, which is referenced by the spatial position of the macroblock in the video sequence and which is updated with an accumulated distortion value. The video encoder is arranged for applying the final encoding mode for encoding the current macroblock.

According to an embodiment of the present invention, the table is provided to maintain the accumulated distortion value, which is updated by that expected distortion value associated with the selected final encoding mode. This means that the accumulated distortion value representing an abstract number indicating expected distortion due to transmission errors is updated each time a macroblock is encoded. The accumulated distortion value is maintained on the basis of the table. Preferably, the accumulated distortion value is initially zero.

According to an embodiment of the present invention, a cost calculator is arranged for determining a cost value for each encoding mode on the basis of the distortion values and encoding parameters. The decision module is arranged for selecting a final encoding mode from the plurality of encoding modes on the basis of a comparison of the cost values.

According to an embodiment of the present invention, the plurality of encoding modes comprises at least Intra encoding mode. The distortion estimator is arranged for estimating a distortion value for Intra mode encoding of the current macroblock from distortion terms describing distortion due to error concealment and distortion due to a previous erroneous transmitted macroblock.

According to an embodiment of the present invention, the plurality of encoding modes comprises at least Inter encoding mode. The distortion estimator arranged for estimating a distortion value for Intra mode encoding of the current macroblock from distortion terms describing distortion due to error concealment, distortion due to a previous erroneous transmitted macroblock and distortion due to error propagation.

According to an embodiment of the present invention, the distortion term describing the distortion due to error concealment comprises a deviation value obtained from the current macroblock and a co-located macroblock at a previous frame applicable for error concealment and a probability value relating to erroneous transmission of the macroblock.

According to an embodiment of the present invention, the distortion term describing the distortion due to previous erroneous transmitted macroblock comprises a distortion value estimated for a macroblock at a previous frame, which is potentially transmitted erroneously, and a probability value relating to erroneous transmission of the macroblock.

According to an embodiment of the present invention, the distortion term describing the distortion due to error propagation comprises a weighted average distortion value determinable from distortion values of reference macroblocks at a previous frame, which are used as references and determinable from a motion vector. The distortion term describing the distortion due to error propagation comprises additionally a probability value relating to a non-occurrence of erroneous transmission of the macroblock.

According to an embodiment of the present invention, the weighted average distortion value is obtained from distortion values of the reference macroblocks. The distortion values are weighted by weight values for averaging, which weight values are proportional to areas of the reference macroblocks, which areas are used as references for predicting the current macroblock.

According to an embodiment of the present invention, the distortion estimator is arranged for estimating the distortion value for Intra encoding modes, which estimation can be implemented in accordance with following equation:
D_{c}^{I}(n,i)=p·Σ(\hat{F}(n,i)−\hat{F}(n−1,i))²+p·D_{c}(n−1,i);
where p is the packet loss probability, n is the frame number, i is the macroblock number, and \hat{F}(n,i) is the reconstructed macroblock in the case of error free transmission.

According to an embodiment of the present invention, the distortion estimator is arranged for estimating the distortion value for Inter encoding modes, which estimation can be implemented in accordance with following equation:
D_{c}^{P}(n,i)=(1−p)· D̅_{c}(n_{ref},i)+p·Σ(\hat{F}(n,i)−\hat{F}(n−1,i))²+p·D_{c}(n−1,i);
where (1−p)· D̅_{c}(n_{ref},i) is the additional term resulting from error propagation, and D̅_{c}(n_{ref},i) is the weighted average channel distortion of all the macroblocks that current macroblock uses as reference.

According to an embodiment of the present invention, the cost calculator arranged for determining the cost values for each encoding mode is also arranged for, for each encoding mode, determining a quantization distortion value resulting from a quantization operation applicable on the current macroblock, providing a Lagrangian parameter associated with the encoding mode and number of bits required for encoding the current macroblock in accordance with the encoding mode; and determining the cost value in dependence from the quantization distortion value, the Lagrangian parameter, the number of bits, and the distortion value associated with the encoding mode.

According to an embodiment of the present invention, the cost calculator is arranged for determining the cost value for one encoding mode out of the plurality of encoding modes in accordance with following equation:
J=D_{S}(n,i)+D_{C}(n,i)+λ_{mode}·R(·);
where Dₛ(n,i) is a distortion value caused by quantization, D_{C}(n,i) is the expected distortion value determined in accordance with the one encoding mode, R is the number of bits that would be used for encoding the current macroblock, and λ_{mode} is the Lagrangian parameter preferably depending on the one encoding mode.

According to another aspect of the present invention, a system enabling adaptive encoding mode selection operable with a video encoder is provided. The video encoder is operable with a plurality of encoding modes for encoding a current macroblock of a video sequence. The video sequence is preferably intended for being transmitted over an error prone communication network, preferably any packet-switched and/or circuit-switched network. A distortion estimator is arranged for estimating expected distortion values due to potential erroneous transmission of the current macroblock in dependence of the encoding modes. A decision module is arranged for selecting a final encoding mode from the plurality of encoding modes on the basis of the distortion values and encoding parameters. Further, a table is comprised, which is referenced by the spatial position of the macroblock in the video sequence and which is updated with an accumulated distortion value. The video encoder is arranged for applying the final encoding mode for encoding the current macroblock.

According to an embodiment of the present invention, the accumulated distortion value, which is stored and maintained by the table, respectively, is updated by that expected distortion value, which is associated with the selected final encoding mode. This means that the accumulated distortion value representing an abstract number indicating expected distortion due to transmission errors is updated each time a macroblock is encoded. The accumulated distortion value is maintained on the basis of the table. Preferably, the accumulated distortion value is initially zero.

According to an embodiment of the present invention, a cost calculator is arranged for determining a cost value for each encoding mode on the basis of the distortion values and encoding parameters. The decision module is arranged for selecting a final encoding mode from the plurality of encoding modes on the basis of a comparison of the cost values.

According to an embodiment of the present invention, the plurality of encoding modes comprises at least Intra encoding mode. The distortion estimator is arranged for estimating a distortion value for Intra mode encoding of the current macroblock from distortion terms describing distortion due to error concealment and distortion due to a previous erroneous transmitted macroblock.

According to an embodiment of the present invention, the plurality of encoding modes comprises at least Inter encoding mode. The distortion estimator arranged for estimating a distortion value for Intra mode encoding of the current macroblock from distortion terms describing distortion due to error concealment, distortion due to a previous erroneous transmitted macroblock and distortion due to error propagation.

According to another aspect of the present invention, a module, preferably a controlling module is provided, which is arranged for enabling adaptive encoding mode selection of a video encoder. The video encoder is operable with a plurality of encoding modes for encoding a current macroblock of a video sequence. The video sequence is preferably intended for being transmitted over an error prone communication network, preferably any packet-switched and/or circuit-switched network. A distortion estimator is arranged for estimating expected distortion values due to potential erroneous transmission of the current macroblock in dependence of the encoding modes. A decision module is arranged for selecting a final encoding mode from the plurality of encoding modes on the basis of the distortion values and encoding parameters. Further, a table is comprised, which is referenced by the spatial position of the macroblock in the video sequence and which is updated with an accumulated distortion value. The module is arranged for instructing the video encoder to apply the final encoding mode for encoding the current macroblock.

Preferably, the module as well as controlling module described above may be connected to, a part of, or implemented in an encoder controller of the video encoder. Typically, the operation of the video encoder is advantageously controlled by the encoder controller, which is connected to the modules and components of the video encoder, which require control for operation. The controlling module as well as the encoder controller encoder controller is adapted to instruct the modules and components of the video encoder to perform the encoding of the input video signal as described above, respectively.

According to an embodiment of the present invention, the accumulated distortion value, which is stored and maintained by the table, respectively, is updated by that expected distortion value, which is associated with the selected final encoding mode. This means that the accumulated distortion value representing an abstract number indicating expected distortion due to transmission errors is updated each time a macroblock is encoded. The accumulated distortion value is maintained on the basis of the table. Preferably, the accumulated distortion value is initially zero.

According to an embodiment of the present invention, a cost calculator is arranged for determining a cost value for each encoding mode on the basis of the distortion values and encoding parameters. The decision module is arranged for selecting a final encoding mode from the plurality of encoding modes on the basis of a comparison of the cost values.

According to an embodiment of the present invention, the plurality of encoding modes comprises at least Intra encoding mode. The distortion estimator is arranged for estimating a distortion value for Intra mode encoding of the current macroblock from distortion terms describing distortion due to error concealment and distortion due to a previous erroneous transmitted macroblock.

According to an embodiment of the present invention, the plurality of encoding modes comprises at least Inter encoding mode. The distortion estimator arranged for estimating a distortion value for Intra mode encoding of the current macroblock from distortion terms describing distortion due to error concealment, distortion due to a previous erroneous transmitted macroblock and distortion due to error propagation.

### BRIEF DESCRIPTION OF THE DRAWINGS

Preferred embodiments of the present invention will now be explained with reference to the accompanying drawings of which:

FIG. 1 shows a block diagram illustrating schematically a system environment according to an embodiment of the present invention;

FIG. 2 shows a block diagram illustrating schematically a processing device according to an embodiment of the present invention;

FIG. 3 shows a block diagram illustrating schematically a video encoder according to an embodiment of the present invention;

FIG. 4 shows a flow diagram illustrating schematically an operational sequence according to an embodiment of the present invention;

FIG. 5 shows schematically an estimation of a channel distortion according to an embodiment of the present invention; and

FIG. 6 shows a block diagram illustrating schematically components enabling the operations sequence of FIG. 4 according to an embodiment of the present invention.

### DETAILED DESCRIPTION

Features and advantages according to the aspects of the invention will become apparent from the following detailed description, taken together with the drawings. It should be noted that same and like components throughout the drawings are indicated with the same reference number. As aforementioned, the description of the embodiments given below is focused on packet-switched erasure prone communication, for the sake of simplification. But, those skilled in the art will appreciate on the basis of the description that the inventive concept is not limited to packet-switched communication, the inventive concept is applicable to any kind of communication including especially circuit- and/or packet-switched communication.

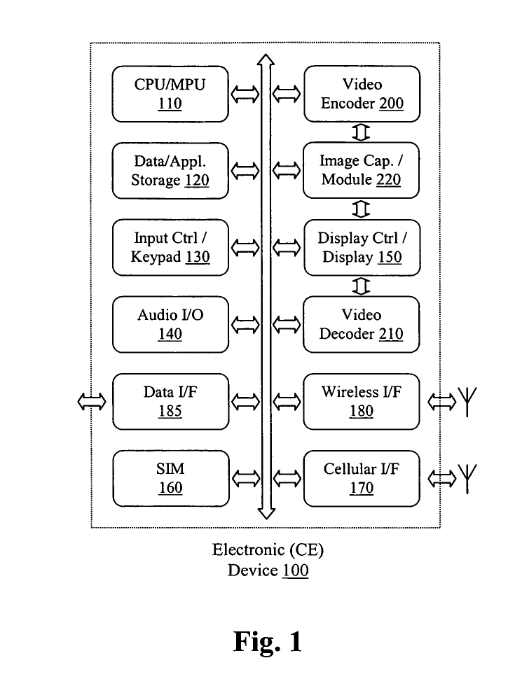

The block diagram of FIG. 1 illustrates principle structural components of an electronic device 100, which should exemplarily represent any kind of processing device employable with the present invention. The electronic device 100 may be a preferably any fixed or portable electronic device. It should be understood that the present invention is neither limited to the illustrated electronic device 100 nor to any other specific kind of processing device.

The illustrated electronic device 100 is exemplarily carried out as a cellular communication enabled user terminal. In particular, the electronic device 100 is embodied as a processor-based or micro-controller based device comprising a central processing unit (CPU) and a mobile processing unit (MPU) 110, respectively, a data and application storage 120, cellular communication means including cellular radio frequency interface (I/F) 170 with radio frequency antenna (outlined) and subscriber identification module (SIM) 160, user interface input/output means including typically audio input/output (I/O) means 140 (typically microphone and loudspeaker), keys, keypad and/or keyboard with key input controller (Ctrl) 130 and a display with display controller (Ctrl) 150, a (local) wireless data interface (I/F) 180, and a general data interface (I/F) 185. Further, the electronic device 100 comprises a video encoder module 200, which is capable for encoding/compressing video input signals to obtain compressed digital video sequences (and e.g. also digital pictures) in accordance with one or more video codecs and especially operable with an image capturing module 220 providing video input signals, and a video decoder module 210 enabled for encoding compressed digital video sequences (and e.g. also digital pictures) in accordance with one or more video codecs.

The operation of the electronic device 100 is controlled by the central processing unit (CPU)/mobile processing unit (MPU) 110 typically on the basis of an operating system or basic controlling application, which controls the functions, features and functionality of the electronic device 100 by offering their usage to the user thereof. The display and display controller (Ctrl) 150 are typically controlled by the processing unit (CPU/MPU) 110 and provides information for the user including especially a (graphical) user interface (UI) allowing the user to make use of the functions, features and functionality of the electronic device 100. The keypad and keypad controller (Ctrl) 130 are provided to enable the user inputting information. The information input via the keypad is conventionally supplied by the keypad controller (Ctrl) to the processing unit (CPU/MPU) 110, which may be instructed and/or controlled in accordance with the input information. The audio input/output (I/O) means 140 includes at least a speaker for reproducing an audio signal and a microphone for recording an audio signal. The processing unit (CPU/MPU) 110 can control conversion of audio data to audio output signals and the conversion of audio input signals into audio data, where for instance the audio data have a suitable format for transmission and storing. The audio signal conversion of digital audio to audio signals and vice versa is conventionally supported by digital-to-analog and analog-to-digital circuitry e.g. implemented on the basis of a digital signal processor (DSP, not shown).

The electronic device 100 according to a specific embodiment illustrated in FIG. 1 includes the cellular interface (I/F) 170 coupled to the radio frequency antenna (not shown) and is operable with the subscriber identification module (SIM) 160. The cellular interface (I/F) 170 is arranged as a cellular transceiver to receive signals from the cellular antenna, decodes the signals, demodulates them and also reduces them to the base band frequency. The cellular interface (I/F) 170 provides for an over-the-air interface, which serves in conjunction with the subscriber identification module (SIM) 160 for cellular communications with a corresponding base station (BS) of a radio access network (RAN) of a public land mobile network (PLMN).

The output of the cellular interface (I/F) 170 thus consists of a stream of data that may require further processing by the processing unit (CPU/MPU) 110. The cellular interface (I/F) 170 arranged as a cellular transceiver is also adapted to receive data from the processing unit (CPU/MPU) 110, which is to be transmitted via the over-the-air interface to the base station (BS) of the radio access network (RAN). Therefore, the cellular interface (I/F) 170 encodes, modulates and up converts the data embodying signals to the radio frequency, which is to be used for over-the-air transmissions. The antenna (not shown) of the electronic device 100 then transmits the resulting radio frequency signals to the corresponding base station (BS) of the radio access network (RAN) of the public land mobile network (PLMN). The cellular interface (I/F) 170 preferably supports a 2nd generation digital cellular network such as GSM (Global System for Mobile Communications) which may be enabled for GPRS (General Packet Radio Service) and/or EDGE (Enhanced Data for GSM Evolution), UMTS (Universal Mobile Telecommunications System), and/or any similar or related standard for cellular telephony standard.

The wireless data interface (I/F) 180 is depicted exemplarily and should be understood as representing one or more wireless network interfaces, which may be provided in addition to or as an alternative of the above described cellular interface (I/F) 170 implemented in the exemplary electronic device 100. A large number of wireless network communication standards are today available. For instance, the electronic device 100 may include one or more wireless network interfaces operating in accordance with any IEEE 802.xx standard, Wi-Fi standard, any Bluetooth standard (1.0, 1.1, 1.2, 2.0 ER), ZigBee (for wireless personal area networks (WPANs)), infra-red Data Access (IRDA), any other currently available standards and/or any future wireless data communication standards such as UWB (Ultra-Wideband).

Moreover, the general data interface (I/F) 185 is depicted exemplarily and should be understood as representing one or more data interfaces including in particular network interfaces implemented in the exemplary electronic device 100. Such a network interface may support wire-based networks such as Ethernet LAN (Local Area Network), PSTN (Public Switched Telephone Network), DSL (Digital Subscriber Line), and/or other current available and future standards. The general data interface (I/F) 185 may also represent any data interface including any proprietary serial/parallel interface, a universal serial bus (USB) interface, a Firewire interface (according to any IEEE 1394/1394a/1394b etc. standard), a memory bus interface including ATAPI (Advanced Technology Attachment Packet Interface) conform bus, a MMC (MultiMediaCard) interface, a SD (SecureData) card interface and the like.

The components and modules illustrated in FIG. 1 may be integrated in the electronic device 100 as separate, individual modules, or in any combination thereof. Preferably, one or more components and modules of the electronic device 100 may be integrated with the processing unit (CPU/MPU) forming a system on a chip (SoC). Such system on a chip (SoC) integrates preferably all components of a computer system into a single chip. A SoC may contain digital, analog, mixed-signal, and also often radio-frequency functions. A typical application is in the area of embedded systems and portable systems, which are constricted especially to size and power consumption constraints. Nevertheless, it should be noted that SoC design is not limited to such embedded or portable system but is also applied for implementing fixed systems. Such a typical SoC consists of a number of integrated circuits that perform different tasks. These may include one or more components comprising microprocessor (CPU/MPU), memory (RAM: random access memory, ROM: read-only memory), one or more UARTs (universal asynchronous receiver-transmitter), one or more serial/parallel/network ports, DMA (direct memory access) controller chips, GPU (graphic processing unit), DSP (digital signal processor) etc. The recent improvements in semiconductor technology have allowed VLSI (Very-Large-Scale Integration) integrated circuits to grow in complexity, making it possible to integrate all components of a system in a single chip.

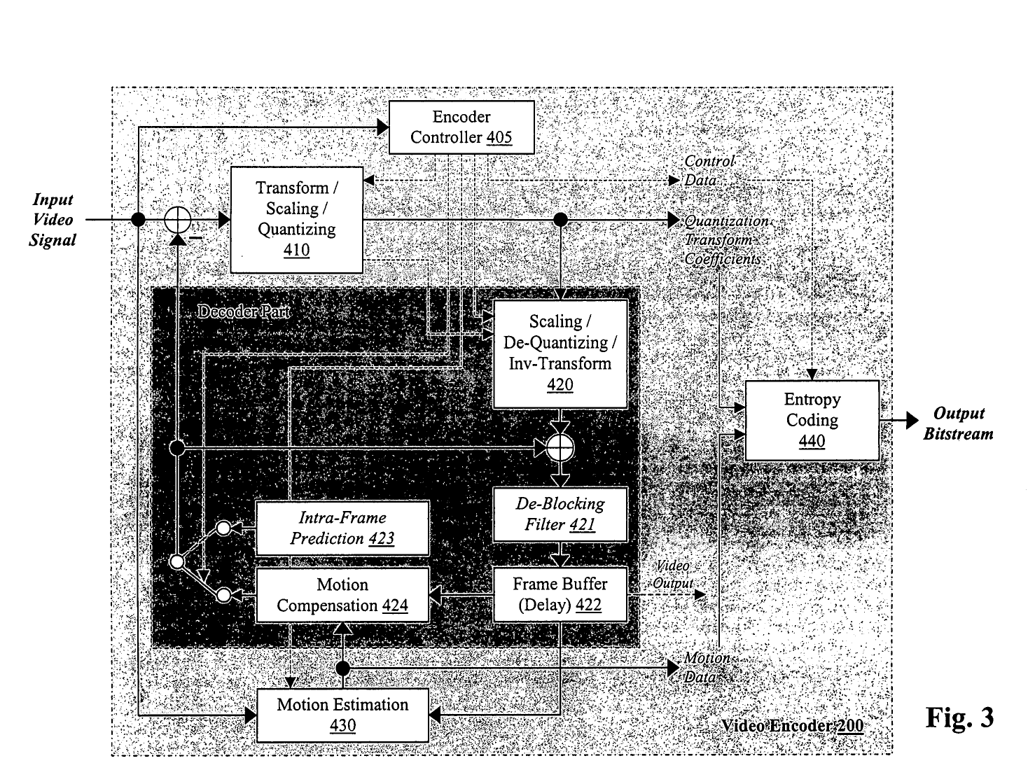

The video encoder is adapted to receive a video input signal and encode a digital video sequence thereof, which can be stored, transmitted via any data communications interface, and/or reproduced by the means of the video decoder 210. The video encoder 200 is operable with any video codecs. The video input signal may be provided by the image capturing module 220 of the electronic device 100. The image capturing module 220 may be implemented or detachably connected to the electronic device 100. An illustrative implementation of the video encoder 200 will be described below with reference to FIG. 3. Reference should be given thereto.

The image capturing module 220 is preferably a sensor for recording images. Typically such an image capturing module 200 consisting of an integrated circuit (IC) containing an array of linked, or coupled, capacitors. Under the control of an external circuit, each capacitor can transfer its electric charge to one or other of its neighbours. Such integrated circuit containing an array of linked, or coupled, capacitors is well known by those skilled in the art as charge-coupled device (CCD). Other image capturing technologies may be also used.

The video decoder 210 is adapted to receive a digitally encoded/compressed video sequence, preferably divided into a plurality of video data packets received via the cellular interface 170, the wireless interface (I/F) 180, any other data interface of the electronic device 100 over a packet-based data communication network or from a data storage connected to the electronic device 100. The video decoder 210 is operable with any video codecs. The video data packets are decoded by the video decoder and preferably outputted to be displayed via the display controller and display 150 to a user of the electronic device 100. Details about the function and implementation of the video decoder 210 are out of the scope of the present invention.

Typical alternative electronic devices may include personal digital assistants (PDAs), hand-held computers, notebooks, so-called smart phones (cellular phone with improved computational and storage capacity allowing for carrying out one or more sophisticated and complex applications), which devices are equipped with one or more network interfaces enabling typically data communications over packet-switched data networks. The implementation of such typical micro-processor based devices capable for processing multimedia contents including encoding multimedia contents is well known in the art.

Those skilled in the art will appreciate that the present invention is not limited to any specific electronic processing-enabled device, which represents merely one possible processing-enabled device, which is capable for carrying out the inventive concept of the present invention. It should be understood that the inventive concept relates to an advantageous implementation of a video encoder 200, which can be implemented on any processing-enabled device including an electronic device as described above, a personal computer (PC), a consumer electronic (CE) device, a server and the like.

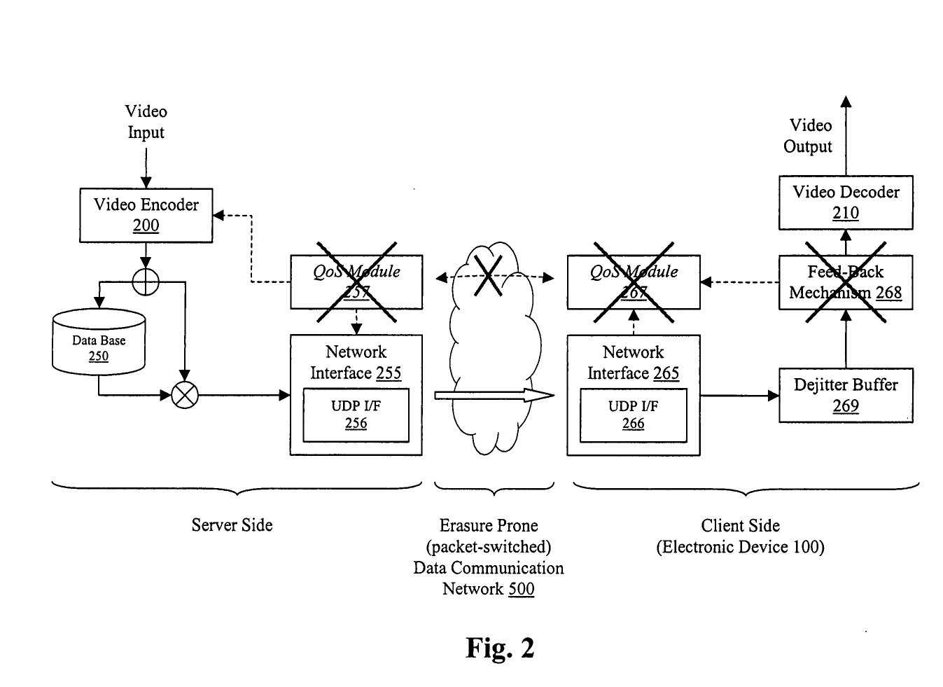

With reference to FIG. 2, an exemplary transmitter-network-receiver arrangement is illustrated by the means of a block diagram. It should be noted that the block diagram includes modules and/or functions on transmitter and receiver side, respectively, which are exemplary shown to illustrate a typical system environment, within which an embodiment of the present invention is operable. The implementation on transmitter and receiver side is not complete. On transmitter side, designated also as server side, video packets of a digitally encoded/compresses video sequence are provided. The video packets are to be transmitted to the receiver side, designated also as client side. The transmission of the video packets is operable with a data communication network 500 which is preferably a packet-switched network. The video packets to be transmitted originate from a video encoder 200, which receives a video input signal and processes the video input signal resulting in a digitally encoded/compressed video sequence. On server side, the digitally encoded/compressed video sequence may be stored in a data base 250 before transmission via the network interface 255 which includes preferably a UDP (universal datagram protocol) interface 256.

On the client side, a corresponding network interface 265 including preferably a corresponding UDP interface 266 is arranged to receive the video packets of the digitally encoded/compressed video sequence transmitted by the transmitter/server. The received video packets are typically forwarded to a buffer storage 269, which puts the received video packets into sequence. Then the video packets are supplied to the video decoder 210 for reproducing the video sequence (on a display) from the video packets.

The network 500 is preferably an erasure prone network such as the Internet or a public land mobile network (PLMN).

As aforementioned, the video decoder 210 would ideally communicate to the video encoder 200 areas in the reproduced picture that are damaged so to allow the encoder to repair only the affected area. This, however, requires a feedback channel. Such a feed-back mechanism is outlined by the means of the feed-back module 268 and the QoS (quality of service) modules 267 on client side and QoS module 257 on server side. In many applications such feed-back mechanisms are not available. In other applications, the round-trip delay is too long to allow for a good video experience. Since the affected area (where the loss related artefacts are visible) normally grows spatially over time due to motion compensation, a long round trip delay leads to the need of more repair data which, in turn, leads to higher (average and peak) bandwidth demands. Hence, when round trip delays become large, feedback-based mechanisms become much less attractive.

FIG. 3 illustrates schematically a basic block diagram of a video encoder according to an embodiment of the present invention. The illustrative video encoder shown in FIG. 3 depicts a hybrid decoder employing temporal and spatial prediction for video encoding.

The first frame or a random access point of a video sequence is generally coded without use of any information other than that contained in the first frame. This type of coding is designated “Intra” coding, i.e. the first frame is typically “Intra” coded. The remaining pictures of the videos sequence or the pictures between random access points of the videos sequence are typically coded using “Inter” coding. “Inter” coding employs prediction (especially motion compensation prediction) from other previously decoded pictures. The encoding process for “Inter” prediction or motion estimation is based on choosing motion data, comprising the reference picture, and a spatial displacement that is applied to all samples of the block. The motion data which is transmitted as side information is used by the encoder and decoder to simultaneously provide the “Inter” prediction signal.

The residual of the prediction (either “Intra” or “Inter”), which is the difference between the original and the predicted block, is transformed. The transform coefficients are scaled and quantized. The transform, scaling and quantizing is performed by component 410 of the video encoder 200. The quantized transform coefficients are entropy coded by the means of the component 440 of the video encoder 200 and transmitted together with the side information for either “Intra”-frame or “Inter”-frame prediction. The encoder contains the decoder to conduct prediction for the next blocks or the next picture. Therefore, the quantized transform coefficients are inverse scaled and inverse transformed by the de-quantizing, scaling, and inverse transform component 420 in the same way as at the decoder side, resulting in the decoded prediction residual. The decoded prediction residual is added to the prediction. The result of that addition is fed into a de-blocking filter component 421, which provides the decoded video as its output and is stored in a frame (delay) buffer 422 enabling motion estimation and motion compensation by the means of the components 430 of the video encoder 200 and 424 of the decoder part of the video encoder 200, respectively.

An input video signal is picture-wise supplied to the encoder input. A picture of a video sequence can be a frame or a field. Each picture is split into macroblocks each having a predefined fixed size. Each macroblock covers a rectangular area of the picture. Preferably, typical macroblocks have an area of 16×16 samples/pixels of the luma component and 8×8 samples/pixels of each of the two chroma components. The luma and chroma samples of a macroblock are spatially or temporally predicted and the resulting prediction residual is transmitted using transform coding. Therefore, each color component of the predicting residual is subdivided into block and each block is transformed using an integer transform such as separable integer transform or discrete cosine transform (DCT) and the transform coefficients are quantized by the means of the transform, scaling, and quantizing component 410. Thereafter, the quantized transforms coefficients are transmitted using any entropy-coding methodology such as the entropy coding component 440.

The macroblocks may be further structured into slices, which represent subsets of a given picture that can be decoded independently. In I slices, all macroblocks are coded without use of any information other than that contained in this picture. In P and B slices, information of prior-coded pictures is used to from a prediction signal for the macroblocks of the predictive-coded P and B slices. Each macroblock can be transmitted in one or more coding types in accordance with the slice-coding type. The prediction may be conducted in transform domain or in spatial domain referring to neighbouring samples of prior-coded blocks.

Besides the “Intra” coding, various predictive or motion-compensated coding types can be specified for P-type macroblocks. Each P-type macroblock corresponds to a specific partitioning of the macroblock into fixed-size blocks used for motion description. The prediction signal for each predictive-coded m×n block is obtained by displacing an area of the corresponding reference picture, which is specified by a translational motion vector and a picture reference index. The motion vector components are typically differentially coded using either median or directional prediction from neighbouring blocks. More than one prior-coded picture may be used as a reference for motion-compensated prediction.

The video encoder 220 has to store the reference pictures used for Inter-picture prediction in a frame (delay) buffer 422. A video decoder receiving the output bitstream of the video decoder 220 replicates the multi-picture buffer of the encoder, according to the reference picture buffering type and any memory management control operations that are specified in the output video bitstream.

In addition to P-slice macroblocks, B-slice macroblocks can be employed for “Inter” coding. The substantial difference between B and P slices is that B slices are coded in a manner, in which some macroblocks or blocks may use a weighted average of two distinct motion-compensated prediction values, for building the prediction signal. Generally, B slices utilize two distinct reference picture buffers, which are referred to as the first and second reference picture buffer (not shown), respectively. Which pictures are actually located in each reference picture buffer is an issue for a buffer control.

One particular characteristic of block-based coding is the occurrence of blocking artefact structures when decoding. A de-blocking filter 421, which is arranged in the decoder loop of the video encoder 220, is used to reduce such blocking artefacts.

The operation of the video encoder 200 is controlled by an encoder controller 405, which is connected to the modules requiring control for operation. The encoder controller 405 instructs the modules to perform the encoding of the input video signal as described above.

It should be noted that the video encoder 200 is described for the way of illustration. The present invention is not limited to any specific video encoder and the detailed setup of a video encoder is out of the scope of the present invention.

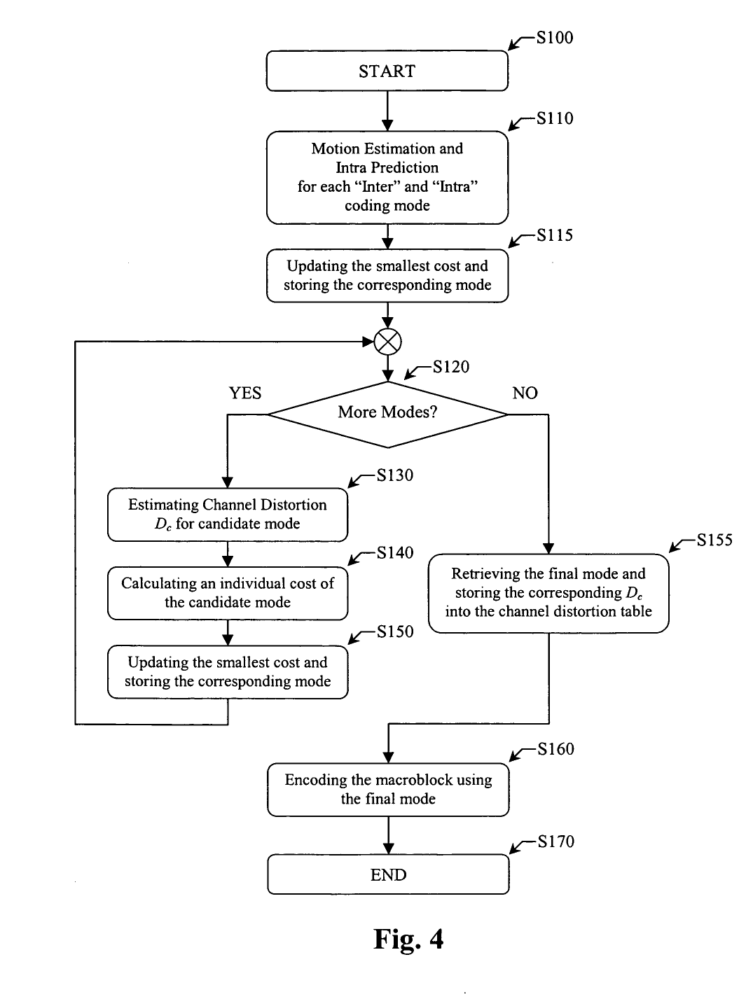

With reference to FIG. 4, a general flowchart of an algorithm according to an embodiment of the present invention is illustrated.

At encoding time and without feedback channel usage, the mode decision process is not aware of the region that is perhaps corrupted due to previous transmission errors. Thus, the mode decision process has to predict the effect of channel distortion and act accordingly, by selecting “appropriate” macroblocks for intra coding. Generally, an encoder should place Intra macroblocks such that the error propagation is minimized.

The operations, shown in FIG. 4 by way of illustration, are operated for each macroblock in order to decide the coding mode of coding the macroblock. The decision of the coding mode to be employed is based on a cost determination in order to select that coding mode.

All (possible and/or desired) candidate modes for coding are processed.

In operation S100, the operational sequence for selecting a coding mode according to an embodiment of the present invention starts.

In operation S110, motion estimation and “Intra” prediction for each “Inter” and “Intra” coding mode is performed.

In case, the candidate mode is “Intra” coding, the distortion of the reconstructed macroblock resulting from the possible packet is estimated. The determination of the distortion will be described below in more detail.

In case the candidate mode is “Inter” coding, motion estimation is performed. By using the motion vector, which has been found in motion estimation process, the distortion for the macroblock is estimated by considering the error propagation characteristics. The determination of the distortion will be described below in more detail.

A cost of each mode is calculated. The costs consider especially the number of bits required for coding, the channel distortion, and the distortion caused by quantization. On the basis of the calculated costs that candidate mode is chosen for coding that gives the smallest cost. The cost, which is determined to result to the smallest cost, the channel distortion, and/or the corresponding mode belonging to the smallest cost, is stored in operation S115.

In operation S 120 there is checked whether further candidate modes should be considered.

If there are further candidate modes, the channel distortion for the macroblock is estimated for each candidate mode in an operation S130 and a cost of the candidate mode is calculated in operation S140. On the basis of the calculated costs and the stored cost that candidate mode is chosen for coding, preferably the mode that gives the smallest cost. The cost, which is determined to result to the smallest cost, the channel distortion, and/or the corresponding mode belonging to the smallest cost is stored in operation S150. The operation sequence returns to operation S120 for continuing.

Otherwise, the final coding mode is retrieved in an operation S155. The final coding mode is that coding mode, which has been stored, due to the smallest cost calculated. The channel distortion DC is stored in the channel distortion table.

In operation S160, the macroblock is encoded using the final coding mode (corresponding to the coding mode having the smallest cost).

In operation S170, the operational sequence for selecting a coding mode according to an embodiment of the present invention is complete.

The channel distortion of a macroblock refers to the distortion caused by possible losses of data during transmission. Since, it is assumed that a feedback channel is not present to accurately inform the encoder about data loss, the channel distortion should be estimated. According to an embodiment of the present invention, the channel distortion is estimated for each macroblock separately. The channel distortion is estimated for every candidate mode of the macroblock. This estimation differs for “Intra” and “Inter” coding modes as for “Inter” coding modes the macroblock is predicted from previous frames whereas “Intra” coding modes do not utilize this kind of prediction.

For “Intra” coding modes, the channel distortion may be caused by distortion due to error concealment and distortion due to a previous erroneous macroblock. According to an embodiment of the present invention, and with reference to error concealment, it is assumed that in the case of loss of a macroblock, the decoder copies the co-located macroblock at the previous frame to conceal the error. It should be obvious to a person skilled in the art that other concealment mechanisms may also be used, refer to the mentioned paper by Wang and Wenger for an in-depth discussion. With reference erroneous macroblock, distortion due to a previous erroneous macroblock is carried to the current frame with error-concealment.

By taking these two sources for channel distortion into account, the channel distortion for an “Intra” coding mode is estimated as:
D_{c}^{I}(n,i)=p·Σ(\hat{F}(n,i)−\hat{F}(n−1,i))²+p·D_{c}(n−1,i); Eq. (1)
where
p is the packet loss probability,
n is the frame number,
i is the macroblock number, and
\hat{F}(n,i) is the reconstructed macroblock in the case of error free transmission.

With reference to equation (1) it should be assumed that in the case of loss of a macroblock, a decoder copies previous co-located macroblock to the current frame. Although, it has been found by simulations that this assumption is valid even for more advanced error concealment techniques, those skilled in the art will appreciate that equation (1) can be modified for different concealment techniques. For “Inter” coding modes, the channel distortion has an additional term to enabling taking error propagation into account. Because “Inter” coded macroblocks are predicted from previous frames (see above), an “inter” macroblock may propagate errors into the current frame even though it is correctly received by the decoder. By considering this additional term, the channel distortion for “inter” coding modes is estimated as:
D_{c}^{P}(n,i)=(1−p)· D̅_{c}(n_{ref},i)+p·Σ(\hat{F}(n,i)−\hat{F}(n−1,i))²+p·D_{c}(n−1,i); Eq. (2)
where
(1−p)· D̅_{c}(n_{ref},i) is the additional term resulting from error propagation, and
D̅_{c}(n_{ref},i) is the weighted average channel distortion of all the macroblocks that current macroblock uses as reference.

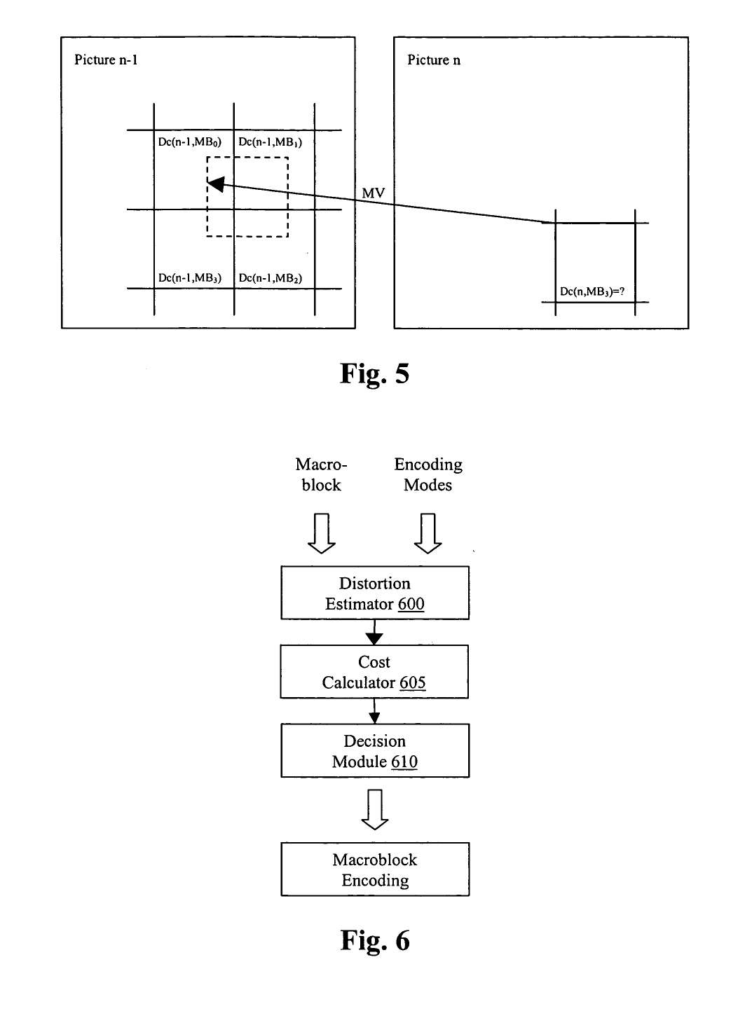

The weight of each reference macroblock is proportional to the area that is being used as reference. FIG. 5 shows an example of how D̅_{c}(n_{ref},i) (the weighted average channel distortion) is calculated. With reference to FIG. 5, the weighted average of channel distortions of four macroblocks at the previous frame is illustrated. These macroblocks and their respective weights are calculated using the motion vector (MV) found in motion estimation process. In this example, MB₁ in picture n−1 (i=1 or macroblock 1) has the largest weight, whereas MB₃ (i=3 or macroblock 3) has the smallest.

For some applications, it may be desirable to “force” the coding mode of a macroblock as “intra”, no matter what the cost of each mode is. One example for a need for such a forcing is compliance with ITU-T Recommendation. H.263 baseline, according to which every macroblock must be coded in intra mode the latest after it was coded 132 times in Inter mode with coefficients present. According to the invention presented, the forcing can be implemented by setting the cost of the “inter” modes to a pre-determined value that is larger than the maximum possible cost.

For each candidate mode, a cost is calculated including the estimated channel distortion and the mode with the smallest cost is chosen. Cost of each mode is calculated using the following equation:
J=D_{S}(n,i)+D_{C}(n,i)+λ_{mode}·R(·); Eq. (3)
where
Dₛ(n,i) is the distortion caused by quantization,
R is the number of bits that would be used for coding the macroblock, and
λ_{mode} is the Lagrangian parameter.

It should be noted that D_{c} is given as zero for frames that will not be used as reference for the subsequent frames. This is because errors in non-reference pictures do not propagate.

It should be noted that the calculation and decision operations described above according to an embodiment of the present invention are operable with the encoder controller 405 shown in FIG. 3, which controls the operation of the video encoder 200.

With reference to FIG. 6 components enabling the calculation and decision operations described above according to an embodiment of the present invention are exemplary illustrated. The present invention relates in general to a mode decision algorithm enabling to select macroblock in a single picture to be Intra encoded at the costs of bandwidth (instead of Inter encoded which is susceptible to erroneous transmission, wherein note that Inter encoding saves bandwidth), so to increase the reproduced video quality under error prone conditions. In brief, the main aspect of the inventive concept and its algorithm comprises the following two elements:
A distortion estimator for each macroblock that reacts to channel errors such as packet losses or errors in video segments that takes potential error propagation in the reproduced video into account.
A mode decision algorithm that chooses the optimal mode based on encoding parameters and the estimated distortion due to channel errors.

A distortion estimator 600 is provided, which is adapted to estimate, for each macroblock, potential error propagation in the reproduced video in response to channel errors such as packet losses or errors in video segments. A cost calculator is provided to determine the cost associated with each estimated channel distortion. A mode decision module 610 is provided which is adapted to choose the optimal mode based on encoding parameters and the estimated distortion due to channel errors for coding the macroblocks. The distortion estimator 600 is supplied with the one or more encoding modes employable for encoding and each macroblocks to be encoded. The distortion estimator 600 is preferably arranged to perform the estimation operations of equation (1) and (2), wherein the cost calculator is preferably arranged to perform the calculation operation of equation (3). The decision module 610 instructs finally which encoding mode is to be used.

It should be noted that the inventive concept is not restricted to combat errors though. A person skilled in the art can easily find other applications for intra refresh, for example to allow for gradual decoder refresh. It should be also noted that the inventive concept is combinable with further error concealment mechanisms, error feed-back mechanisms and forward error correction mechanisms, which are known in the art or which will become available in the future. It will be understood that various details of the invention may be changed without departing from the scope of the present invention. Furthermore, the foregoing description is for the purpose of illustration only, and not for the purpose of limitation—the invention being defined by the claims.

What is claimed is:

1. A method for adaptive encoding mode selection applicable with a video encoder operable with a plurality of encoding modes for encoding a current macroblock at a spatial position of a video sequence, said method comprising operations of:
estimating expected distortion values due to potential erroneous transmission of the current macroblock in dependence of the encoding modes;
selecting a final encoding mode from the plurality of encoding modes on the basis of at least one of the distortion values and encoding parameters;
updating an accumulated distortion value in a table referenced by the spatial position; and
applying the final encoding mode for encoding said current macroblock.

2. The method according to claim 1, comprising:
updating the accumulated distortion value by the expected distortion value associated with the selected final encoding mode; wherein the accumulated distortion value is preferably initially zero.

3. The method according to claim 1, comprising:
determining a cost value for substantially each encoding modes on the basis of the distortion values and encoding parameters; and
selecting the final encoding mode on the basis of a comparison of the cost values.

4. The method according to claim 1, wherein the plurality of encoding modes comprises at least Intra encoding mode, the method comprising:
estimating a distortion value for Intra mode encoding of current macroblock from distortion terms describing distortion due to error concealment and distortion due to previous erroneous transmitted macroblock.

5. The method according to claim 1, wherein the plurality of encoding modes comprises at least Inter encoding mode, said method comprising:
estimating a distortion value for Inter mode encoding of current macroblock from distortion terms describing distortion due to error concealment, distortion due to previous erroneous transmitted macroblock and distortion due to error propagation.

6. The method according to claim 4, wherein the distortion term describing the distortion due to error concealment comprises a deviation value obtained from current macroblock and co-located macroblock at previous frame applicable for error concealment and a probability value relating to potentially erroneous transmission of current macroblock.

7. The method according to claim 4, wherein the distortion term describing the distortion due to previous erroneous transmitted macroblock comprises a distortion value estimated for a macroblock at previous frame, which is potentially transmitted erroneously, and a probability value relating to potentially erroneous transmission of current macroblock.

8. The method according to claim 5, wherein the distortion term describing the distortion due to error propagation comprises a weighted average distortion value determinable from distortion values of reference macroblocks at previous frame, which are used as references and determinable from a motion vector, wherein the distortion term describing the distortion due to error propagation comprises additionally a probability value relating to non-occurrence of potentially erroneous transmission of current macroblock.

9. The method according to claim 8, wherein the weighted average distortion value is obtained from distortion values of the reference macroblocks, which distortion values are weighted for averaging by weight values, which are proportional to areas of said reference macroblocks, which areas are used as references for predicting said current macroblock.

10. The method according to claim 4, wherein the distortion value for Intra encoding modes is estimated in accordance with following equation:
D_{c}^{I}(n,i)=p·Σ(\hat{F}(n,i)−\hat{F}(n−1,i))²+p·D_{c}(n−1,i);
where p is packet loss probability, n is frame number, i is macroblock number, and \hat{F}(n,i) is reconstructed macroblock in case of error free transmission.

11. The method according to claim 5, wherein the distortion value for Inter encoding modes is estimated in accordance with following equation:
D_{c}^{P}(n,i)=(1−p)· D̅_{c}(n_{ref},i)+p·Σ(\hat{F}(n,i)−\hat{F}(n−1,i)+p·D_{c}(n−1,i);
where (1−p)·D_{c}(n_{ref},i) is additional term resulting from error propagation, and D̅_{c}(n_{ref},i) is weighted average channel distortion of all macroblocks that said current macroblock uses as reference.

12. The method according to claim 3, wherein the determining the cost values for substantially all encoding mode comprises, for each encoding mode,
determining a quantization distortion value resulting from a quantization operation applicable on the current macroblock;
providing a Lagrangian parameter associated with the encoding mode and number of bits required for encoding current macroblock in accordance with the encoding mode; and
determining the cost value in dependence from the quantization distortion value, the Lagrangian parameter, the number of bits, and the distortion value associated with the encoding mode.

13. The method according to claim 3, wherein said cost value for one encoding mode out of said plurality of encoding modes is determined in accordance with following equation:
J=D_{S}(n,i)+D_{C}(n,i)+λ_{mode}·R(·);
where Dₛ(n,i) is distortion value caused by quantization, D_{C}(n,i) is expected distortion value determined in accordance with one encoding mode, R is number of bits that would be used for encoding current macroblock, and λ_{mode} is Lagrangian parameter preferably depending on one encoding mode.

14. A computer program product comprising a computer readable medium having a program code recorded thereon for adaptive encoding mode selection applicable with a video encoder operable with a plurality of encoding modes for encoding a current macroblock of a video sequence;
said program code comprising:
said video encoder;
said program code when executed by a processor having:
a code section for estimating expected distortion values due to potential erroneous transmission of said current macroblock in dependence of said encoding modes;
a code section for selecting a final encoding mode from said plurality of encoding modes on the basis of said distortion values and encoding parameters;
a code section for updating an accumulated distortion value in a table referenced by said spatial position; and
a code section for applying said final encoding mode for encoding said current macroblock.

15. The computer program product according to claim 14, comprising:
a code section for updating said accumulated distortion value by said expected distortion value associated with said selected final encoding mode;
wherein said accumulated distortion value is preferably initially zero.

16. The computer program product according to claim 14, comprising:
a code section for determining a cost value for each encoding mode on the basis of said distortion values and encoding parameters; and
a code section for selecting a final encoding mode from said plurality of encoding modes on the basis of a comparison of said cost values.

17. The computer program product according to claim 14, wherein said plurality of encoding modes comprises at least Intra encoding mode, said program code comprising:
a code section for estimating a distortion value for Intra mode encoding of said current macroblock from distortion terms describing distortion due to error concealment and distortion due to a previous erroneous transmitted macroblock.

18. The computer program product according to claim 14, wherein said plurality of encoding modes comprises at least Inter encoding mode, said program code comprising:
a code section for estimating a distortion value for Inter mode encoding of said current macroblock from distortion terms describing distortion due to error concealment, distortion due to a previous erroneous transmitted macroblock and distortion due to error propagation.

19. The computer program product according to claim 17, wherein said distortion value for Intra encoding modes is estimated in accordance with following equation:
D_{c}^{I}(n,i)=p·Σ(\hat{F}(n,i)−\hat{F}(n−1,i))²+p·D_{c}(n−1,i)
where p is a packet loss probability, n is a frame number, i is a macroblock number, and \hat{F}(n,i) is a reconstructed macroblock in case of error free transmission.

20. The computer program product according to claim 18, wherein said distortion value for Inter encoding modes is estimated in accordance with following equation:
D_{c}^{P}(n,i)=(1−p)· D̅_{c}(n_{ref},i)+p·Σ(\hat{F}(n,i)−\hat{F}(n−1,i))²+p· D̅_{c}(n−1,i);
where (1−p)· D̅_{c}(n_{ref},i) is an additional term resulting from error propagation, and D̅_{c}(n_{ref},i) is a weighted average channel distortion of all macroblocks that said current macroblock uses as reference.

21. The computer program product according to claim 16, wherein said code section for determining said cost values for each encoding mode comprises, for each encoding mode,
a code section for determining a quantization distortion value resulting from a quantization operation applicable on said current macroblock;
a code section for providing a Lagrangian parameter associated with said encoding mode and number of bits required for encoding said current macroblock in accordance with said encoding mode; and
a code section for determining said cost value in dependence from said quantization distortion value, said Lagrangian parameter, said number of bits, and said distortion value associated with said encoding mode.

22. The computer program product according to claim 16, wherein said cost value for one encoding mode out of said plurality of encoding modes is determined in accordance with following equation:
J=D_{S}(n,i)+D_{C}(n,i)+λ_{mode}·R(·);
where Dₛ(n,i) is a distortion value caused by quantization, D_{C}(n,i) is an expected distortion value determined in accordance with said one encoding mode, R is a number of bits that would be used for encoding said current macroblock, and λ_{mode} is a Lagrangian parameter preferably depending on said one encoding mode.

23. A video encoder arranged for adaptive encoding mode selection, said video encoder being operable with a plurality of encoding modes for encoding a current macroblock of a video sequence;
said video encoder comprising:
a distortion estimator arranged for estimating expected distortion values due to potential erroneous transmission of said current macroblock in dependence of said encoding modes;
a decision module arranged for selecting a final encoding mode from said plurality of encoding modes on the basis of said distortion values and encoding parameters; and
a table comprising an updated accumulated distortion value, wherein said table is referenced by said spatial position;
wherein said video encoder is arranged for applying said final encoding mode for encoding said current macroblock.

24. The video encoder according to claim 23, comprising:
said table is arranged for storing said accumulated distortion value, which is updated by said expected distortion value associated with said selected final encoding mode, wherein said accumulated distortion value is preferably initially zero.

25. The video encoder according to claim 23, comprising:
a cost calculator arranged for determining a cost value for each encoding mode on the basis of said distortion values and encoding parameters; and
said decision module arranged for selecting a final encoding mode from said plurality of encoding modes on the basis of a comparison of said cost values.

26. The video encoder according to claim 23, wherein said plurality of encoding modes comprises at least Intra encoding mode, said video encoder comprising:
said distortion estimator arranged for estimating a distortion value for Intra mode encoding of said current macroblock from distortion terms describing distortion due to error concealment and distortion due to a previous erroneous transmitted macroblock.

27. The video encoder according to claim 23, wherein said plurality of encoding modes comprises at least Inter encoding mode, said video encoder comprising:
said distortion estimator arranged for estimating a distortion value for Inter mode encoding of said current macroblock from distortion terms describing distortion due to error concealment, distortion due to a previous erroneous transmitted macroblock and distortion due to error propagation.

28. The video encoder according to claim 26, wherein said distortion term describing said distortion due to error concealment comprises a deviation value obtained from said current macroblock and a co-located macroblock at a previous frame applicable for error concealment and a probability value relating to erroneous transmission of said macroblock.

29. The video encoder according to claim 26, wherein said distortion term describing said distortion due to previous erroneous transmitted macroblock comprises a distortion value estimated for a macroblock at a previous frame, which is potentially transmitted erroneously, and a probability value relating to erroneous transmission of said macroblock.

30. The video encoder according to claim 27, wherein said distortion term describing said distortion due to error propagation comprises a weighted average distortion value determinable from distortion values of reference macroblocks at a previous frame, which are used as references and determinable from a motion vector, wherein said distortion term describing said distortion due to error propagation comprises additionally a probability value relating to a non-occurrence of erroneous transmission of said macroblock.

31. The video encoder according to claim 30, wherein said weighted average distortion value is obtained from distortion values of said reference macroblocks, which distortion values are weighted for averaging by weight values, which are proportional to areas of said reference macroblocks, which areas are used as references for predicting said current macroblock.

32. A processing device operable with a video encoder arranged for adaptive encoding mode selection, said video encoder being operable with a plurality of encoding modes for encoding a current macroblock of a video sequence;
said processing device comprising:
said video encoder;
a distortion estimator arranged for estimating expected distortion values due to potential erroneous transmission of said current macroblock in dependence of said encoding modes;
a decision module arranged for selecting a final encoding mode from said plurality of encoding modes on the basis of said distortion values and encoding parameters; and
a table comprising an updated accumulated distortion value, wherein said table is referenced by said spatial position;
wherein said video encoder is arranged for applying said final encoding mode for encoding said current macroblock.

33. The processing device according to claim 32, comprising:
said table arrange for storing said accumulated distortion value, which is updated by said expected distortion value associated with said selected final encoding mode, wherein said accumulated distortion value is preferably initially zero.

34. The processing device according to claim 32, comprising:
a cost calculator arranged for determining a cost value for each encoding mode on the basis of said distortion values and encoding parameters; and
said decision module arranged for selecting a final encoding mode from said plurality of encoding modes on the basis of a comparison of said cost values.

35. The processing device according to claim 32, wherein said plurality of encoding modes comprises at least Intra encoding mode, said processing device comprising:
said distortion estimator arranged for estimating a distortion value for Intra mode encoding of said current macroblock from distortion terms describing distortion due to error concealment and distortion due to a previous erroneous transmitted macroblock.

36. The processing device according to claim 32, wherein said plurality of encoding modes comprises at least Inter encoding mode, said processing device comprising:
said distortion estimator arranged for estimating a distortion value for Inter mode encoding of said current macroblock from distortion terms describing distortion due to error concealment, distortion due to a previous erroneous transmitted macroblock and distortion due to error propagation.

37. The processing device according to claim 35, wherein said distortion term describing said distortion due to error concealment comprises a deviation value obtained from said current macroblock and a co-located macroblock at a previous frame applicable for error concealment and a probability value relating to erroneous transmission of said macroblock.

38. The processing device according to claim 35, wherein said distortion term describing said distortion due to previous erroneous transmitted macroblock comprises a distortion value estimated for a macroblock at a previous frame, which is potentially transmitted erroneously, and a probability value relating to erroneous transmission of said macroblock.

39. The processing device according to claim 36, wherein said distortion term describing said distortion due to error propagation comprises a weighted average distortion value determinable from distortion values of reference macroblocks at a previous frame, which are used as references and determinable from a motion vector, wherein said distortion term describing said distortion due to error propagation comprises additionally a probability value relating to a non-occurrence of erroneous transmission of said macroblock.

40. The processing device according to claim 39, wherein said weighted average distortion value is obtained from distortion values of said reference macroblocks, which distortion values are weighted for averaging by weight values, which are proportional to areas of said reference macroblocks, which areas are used as references for predicting said current macroblock.

41. The processing device according to claim 35, wherein said distortion estimator arranged for estimating said distortion value for Intra encoding modes is operable in accordance with following equation:
D_{c}^{I}(n,i)=p·Σ(\hat{F}(n,i)−\hat{F}(n−1,i))²+p·D_{c}(n−1,i);
where p is a packet loss probability, n is a frame number, i is a macroblock number, and \hat{F}(n,i) is a reconstructed macroblock in case of error free transmission.

42. The processing device according to claim 36, wherein said distortion estimator arranged for estimating said distortion value for Inter encoding modes is operable in accordance with following equation:
D_{c}^{P}(n,i)=(1−p)· D̅_{c}(n_{ref},i)+p·Σ(\hat{F}(n,i)−\hat{F}(n−1,i)²+p·D_{c}(n−1,i);
where (1−p)· D̅_{c}(n_{ref},i) is an additional term resulting from error propagation, and D̅_{c}(n_{ref},i) is a weighted average channel distortion of all macroblocks that said current macroblock uses as reference.

43. The processing device according to claim 34, wherein said cost calculator arranged for determining said cost values for each encoding mode is additionally arranged for, for each encoding mode,
determining a quantization distortion value resulting from a quantization operation applicable on said current macroblock;
providing a Lagrangian parameter associated with said encoding mode and number of bits required for encoding said current macroblock in accordance with said encoding mode; and
determining said cost value in dependence from said quantization distortion value, said Lagrangian parameter, said number of bits, and said distortion value associated with said encoding mode.

44. The processing device according to claim 34, wherein said cost calculator arranged for determining said cost value for one encoding mode out of said plurality of encoding modes in accordance with following equation:
J=D_{S}(n,i)+D_{C}(n,i)+λ_{mode}·R(·);
where Dₛ(n,i) is a distortion value caused by quantization, D_{C}(n,i) is an expected distortion value determined in accordance with said one encoding mode, R is a number of bits that would be used for encoding said current macroblock, and λ_{mode} is a Lagrangian parameter preferably depending on said one encoding mode.

45. A system arranged for adaptive encoding mode selection operable with a video encoder, said video encoder being operable with a plurality of encoding modes for encoding a current macroblock of a video sequence;
said system comprising:
said video encoder;
a distortion estimator arranged for estimating expected distortion values due to potential erroneous transmission of said current macroblock in dependence of said encoding modes;
a decision module arranged for selecting a final encoding mode from said plurality of encoding modes on the basis of said distortion values and encoding parameters; and
a table comprising an updated accumulated distortion value, wherein said table is referenced by said spatial position;
wherein said video encoder is arranged for applying said final encoding mode for encoding said current macroblock.

46. The system according to claim 45, comprising:
said table arranged for storing said accumulated distortion value, which is updated by said expected distortion value associated with said selected final encoding mode, wherein said accumulated distortion value is preferably initially zero.

47. The system according to claim 45, comprising:
a cost calculator arranged for determining a cost value for each encoding mode on the basis of said distortion values and encoding parameters; and
said decision module arranged for selecting a final encoding mode from said plurality of encoding modes on the basis of a comparison of said cost values.

48. The system according to claim 45, wherein said plurality of encoding modes comprises at least Intra encoding mode, said processing device comprising:
said distortion estimator arranged for estimating a distortion value for Intra mode encoding of said current macroblock from distortion terms describing distortion due to error concealment and distortion due to a previous erroneous transmitted macroblock.

49. The system according to claim 45, wherein said plurality of encoding modes comprises at least Inter encoding mode, said processing device comprising:
said distortion estimator arranged for estimating a distortion value for Inter mode encoding of said current macroblock from distortion terms describing distortion due to error concealment, distortion due to a previous erroneous transmitted macroblock and distortion due to error propagation.

50. A module arranged for adaptive encoding mode selection applicable with a video encoder, said video encoder being operable with a plurality of encoding modes for encoding a current macroblock of a video sequence;
wherein said module is arranged for controlling said video encoder; said module comprising:
a distortion estimator arranged for estimating expected distortion values due to potential erroneous transmission of said current macroblock in dependence of said encoding modes;
a decision module arranged for selecting a final encoding mode from said plurality of encoding modes on the basis of said distortion values and encoding parameters; and
a table comprising an updated accumulated distortion value, wherein said table is referenced by said spatial position;
wherein said module is arranged for instructing said video encoder to apply said final encoding mode for encoding said current macroblock.

51. The module according to claim 50, comprising
said table arranged to store said accumulated distortion value, which is updated by said expected distortion value associated with said selected final encoding mode, wherein said accumulated distortion value is preferably initially zero.

52. The module according to claim 50, comprising:
a cost calculator arranged for determining a cost value for each encoding mode on the basis of said distortion values and encoding parameters; and
said decision module arranged for selecting a final encoding mode from said plurality of encoding modes on the basis of a comparison of said cost values.

53. The module according to claim 50, wherein said plurality of encoding modes comprises at least Intra encoding mode, said processing device comprising:
said distortion estimator arranged for estimating a distortion value for Intra mode encoding of said current macroblock from distortion terms describing distortion due to error concealment and distortion due to a previous erroneous transmitted macroblock.

54. The module according to claim 50, wherein said plurality of encoding modes comprises at least Inter encoding mode, said processing device comprising:
said distortion estimator arranged for estimating a distortion value for Inter mode encoding of said current macroblock from distortion terms describing distortion due to error concealment, distortion due to a previous erroneous transmitted macroblock and distortion due to error propagation.
